(19) United States
(12) Patent Application Publication
(10) Pub. No.: US 2015/0027603 A1
(43) Pub. Date: Jan. 29, 2015

(54) PROTECTIVE COVER FOR LAPTOP KEYBOARD

(71) Applicant: Matthew Mogol, Sag Harbor, NY (US)

(72) Inventor: Matthew Mogol, Sag Harbor, NY (US)

(21) Appl. No.: 14/341,656

(22) Filed: Jul. 25, 2014

Related U.S. Application Data
(60) Provisional application No. 61/858,525, filed on Jul. 25, 2013.

(51) Int. Cl. G06F 1/16; B41J 29/13

(52) U.S. Cl. CPC G06F 1/1616; B41J 29/13
USPC 150/154

(57) ABSTRACT

Protective covers for a laptop computer that are configured to prevent unintended access to the keyboard of the laptop. The protective cover is configured to physically block the keyboard from inadvertent engagement. The protective cover protects laptop computer keyboards from damaged by spilling fluids, food or other objects onto the keyboard. The laptop protective cover is easily removable by the user for access to the keyboard and may include one or more straps for securing the cover to the laptop base. The protective cover is of a simple and easy to use designed, lightweight, easily portable, effective and are capable of being inexpensively manufactured.

### CROSS-REFERENCE TO RELATED APPLICATIONS

This application claims the benefit of U.S. Provisional Application Ser. No. 61/858,525 filed Jul. 25, 2013, the content of which is hereby incorporated herein by reference.

### BACKGROUND OF THE INVENTION

The present invention relates to the field of portable electronic devices. The present invention is more particularly directed to protective removable covers for use with laptop computers.

Laptop computers are susceptible to unwanted actions, such as accidental pressing of the keys, the track pad and control buttons. In addition, laptop computer keyboards may damaged by spilling fluids, food or other objects onto the keyboard.

Accordingly, what has been needed and heretofore unavailable is a unique and simple designed protective cover for a laptop computer that is lightweight, easily portable, effective, and is capable of being inexpensively manufactured. The present invention disclosed herein satisfies these and other needs.

### SUMMARY OF THE INVENTION

The present invention is directed to a case or protective cover that protects a keyboard of a laptop computer. The protective cover protects laptop computer keyboards from damaged by spilling fluids, food or other objects onto the keyboard. The protective cover also prevents unwanted actions, such as accidental pressing of the typing keys, use of the track pad and function, control and power buttons.

One aspect of the protective cover of the present invention is configured in the form of a substantially flat, thin rectangular shaped slate. The top portion of the slate is wider than the remainder of the slate, having a rectangular or oval cutout (open section) for allowing the protective cover to slide over the lid of a laptop computer where the display screen is located. An elastomeric ring may or may not be configured within the inside edges of the cutout so as to provide a better grip and to secure the protective cover to various sized laptop display screens. The cutout may or may not be open so that the top portion of the protective cover does not completely wrap around the laptop lid (screen). The lower portion of the protective cover may be configured with two or more narrow slots to retain one or more straps disposed in the slots and wrapped around the underside of the base of the laptop to secure the protective cover to the keyboard portion of the laptop computer. The strap used to secure the protective cover to the base portion of the laptop keyboard may include VELCRO (hook-and-loop fasteners) and/or may be made from an elastic material.

The protective cover for use with a laptop computer includes an upper body section formed with an elongate cutout for receiving the laptop lid (screen). The cutout may be rectangular or oval shaped and may completely or partially enclose the laptop lid with a gripping (rubber) material inside edge the cutout or not. The protective cover further includes a lower body section formed as flat slate having a width smaller than the top body section for covering the laptop keyboard. The slate may include two slits on each side for use with a securing strap (for example, having VELCRO on the ends) for wrapping around the laptop base and fastening within the slits. Alternatively, elastic straps may be configured at the protective cover's corners to secure to the corners of the laptop. The slate may formed with at least two foldable sections to allow access to a portion of the keyboard while the top portion of the protective cover is still engaged with the laptop lid. The slate may be made from various materials, such as plastic, metal or cardboard with an upper finish suitable for use with an erasable marker or for imprinting with colored graphics. The slate may be configured with decorative and/or functional buttons, such as play, pause and volume controls.

The present invention also includes a method for using a protective cover on a laptop computer. The upper body section of the laptop protective cover having an elongate cutout is placed of the over a lid of a laptop computer to completely or partially surround the lid (screen). The middle portion (slate) of the protective cover's lower body section is then moved into engagement with a base of the laptop to cover the keyboard in the laptop base. A strap may be inserted within first vertical and second vertical cutouts in the slate, and then the strap is engaged with the base of the laptop so as to secure the protective cover to the laptop. Alternatively, the middle portion of the lower body section is formed with two vertical cutouts and two horizontal cutouts configured near the corners of the bottom portion of the protective cover's lower section. A first strap is placed within one set cutouts and a second strap is placed within the other set of cutouts. The straps are then wrapped around the corners of the base of the laptop so as to secure the protective cover to the laptop.

Other features and advantages of the invention will become apparent from the following detailed description, taken in conjunction with the accompanying drawings, which illustrate, by way of example, the features of the invention.

### BRIEF DESCRIPTION OF THE DRAWINGS

FIG. 1A is a front plan view of a protective cover of the present invention configured as a slate for resting on the keyboard of a laptop computer, wherein the slate has a rectangular cutout in a top section of the slate.

FIG. 1B is a cross-sectional view of a protective cover of the present invention taken along the line B-B in FIG. 1A.

FIG. 2 is a rear plan view of a protective cover of the present invention showing raised feet on the underside of the slate.

FIG. 3 is a front plan view of an alternative embodiment of the protective cover in accordance with present invention configured as a slate for resting on the keyboard of a laptop computer, wherein the slate has an oval-shaped cutout in a top section of the slate.

FIG. 4A is a top perspective view of the protective cover shown in FIG. 1A, wherein the cutout is positioned around a lid of a laptop computer.

FIG. 4B is a top perspective view of the protective cover shown in FIG. 1A, wherein the bottom section of the protective cover is positioned adjacent a keyboard of the laptop.

FIG. 5A is a front plan view of an alternative embodiment of a protective cover in accordance with the present invention, wherein a bottom portion of the protective cover includes two sets of slits configured at opposite lower corners of the protective cover.

FIG. 5B is a top perspective view of the protective cover shown in FIG. 5A, wherein a cutout in a top portion is positioned at the bottom of a laptop computer lid and a bottom portion of the protective cover is positioned adjacent a keyboard of the laptop such that straps positioned within the slits engage a base of the laptop.

FIG. 6A is a side perspective view of an alternative embodiment of the protective cover in accordance with present invention, wherein a bottom section is configured as a foldable slate.

FIG. 6B is a side perspective view of the protective cover shown in FIG. 6A, wherein the bottom section of the protective cover is positioned adjacent a keyboard of the laptop and the bottom section is folded to expose a portion of the keyboard.

FIG. 7 is a top perspective view of an alternative embodiment of the protective cover in accordance with present invention, wherein the protective cover is configured as a slate having a plurality of raised buttons on an upper side of a bottom section of the slate.

### DETAILED DESCRIPTION

As shown in the attached exemplary drawings, the of the present invention for protective cover used with various styles laptop computers is shown and described as follows:

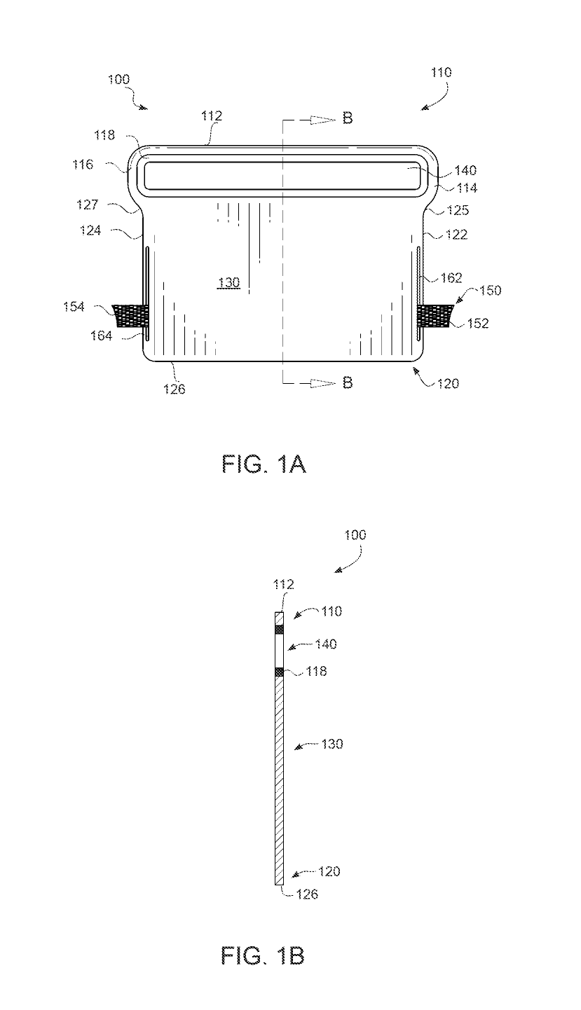

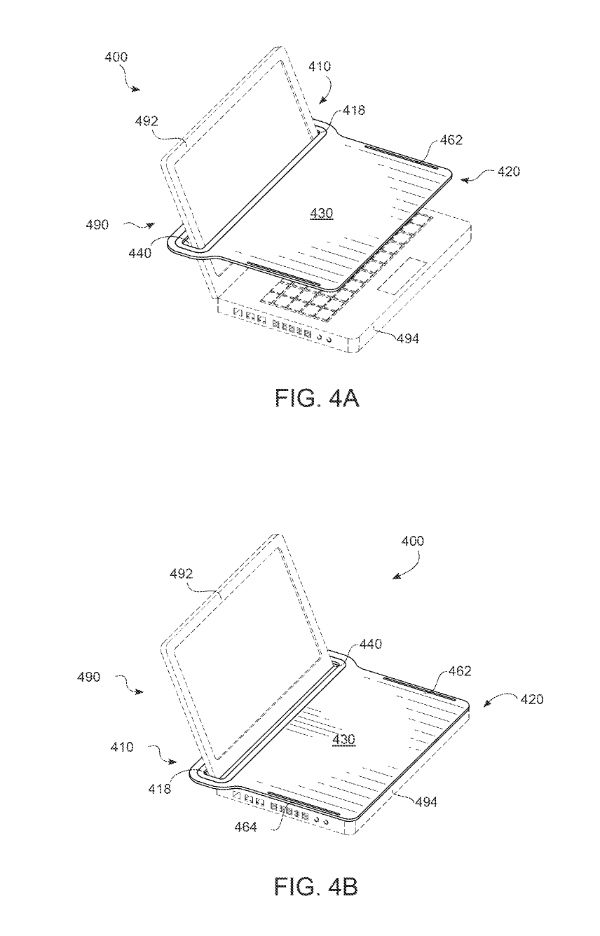

As shown in FIGS. 1A and 1B, the protective cover 100 includes a first (top) body section 110 and a second (bottom) section having a width less than the top section and sized for covering the laptop keyboard (see FIGS. 4A, 4B). The top section is formed with a first (upper) end portion 112, a second (lower) end portion 114 and a middle portion 116 between the upper lower portions. The middle of the top section is configured with an elongate cutout 140 for receiving the laptop lid (cover) and screen (see FIGS. 4A, 4B). The cutout may be rectangular or oval in shape (FIG. 3). A gripping surface 118 (formed from a rubber, elastomer, plastic or other suitable material) may be configured on the inside surface of the cutout to engage and secure the laptop cover.

The bottom section 120 is formed as a slate (substantially flat and rectangular), having an upper end portion 122, 124 and a bottom edge 126. The bottom section is integral with (connected to, continuous with) the top section having a curved portion 125, 127 that may flex, allowing the top section to engage a table or other surface supporting the laptop. The bottom section of the protective cover includes a middle portion 130 forming a flat slate, and may be configured with two vertical slits 162, 164 for receiving a securing strap 150. The ends 152, 154 of the strap may include a fastening mechanism, such as a clasp, snap or VELCRO (hook-and-loop material).

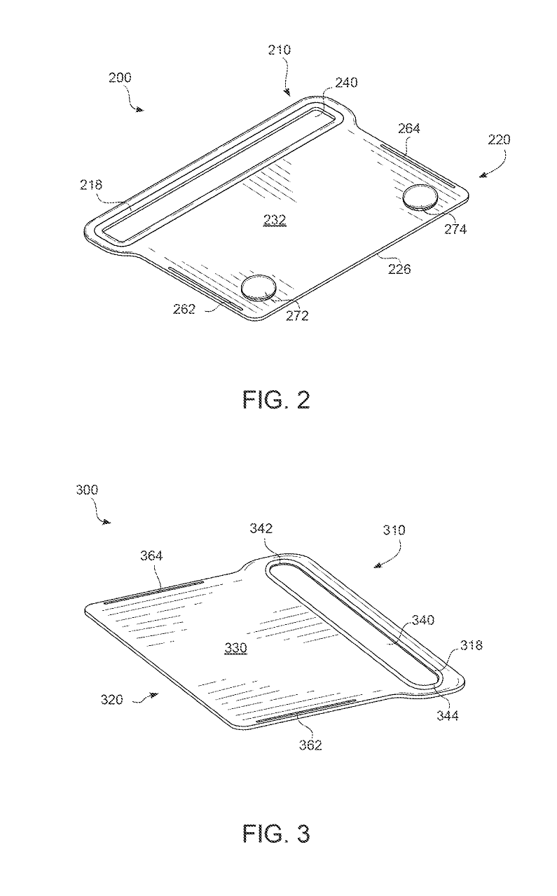

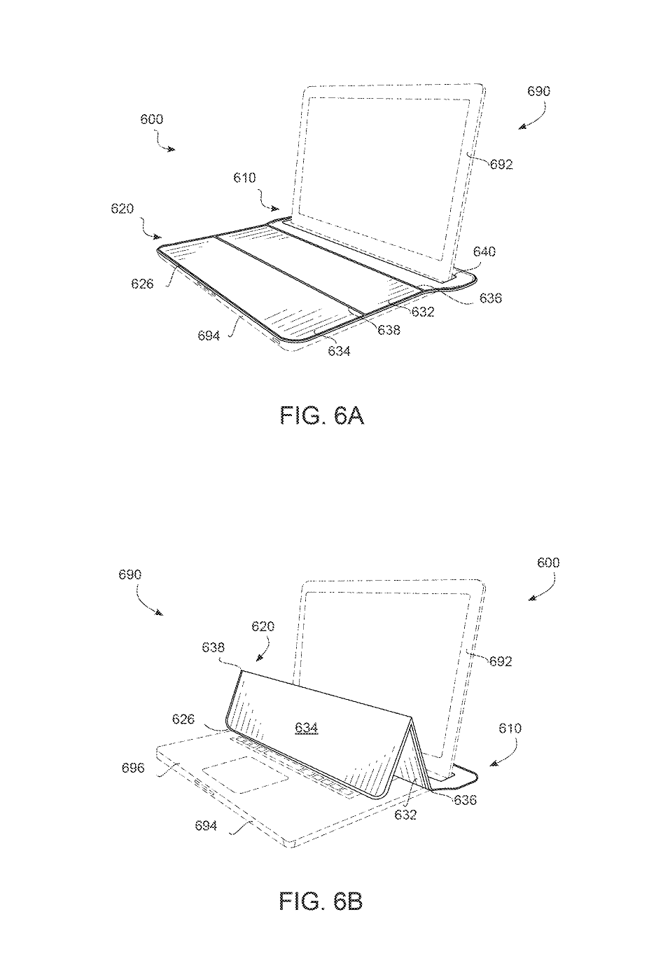

As shown in FIG. 2, the middle portion's back side 232 of the protective cover 200 may include one or more raised portions 272, 274 (for example, round rubber feet about twenty millimeters in diameter) positioned near the bottom edge 226 of the bottom (lower) section 220 and inside of the vertical slots 262, 264. The raised portions prevent the slate from engaging any buttons on the keyboard when the cutout 240 and ring 218 of the top (upper) section 210 are placed over the laptop lid (see FIGS. 4A and 6A).

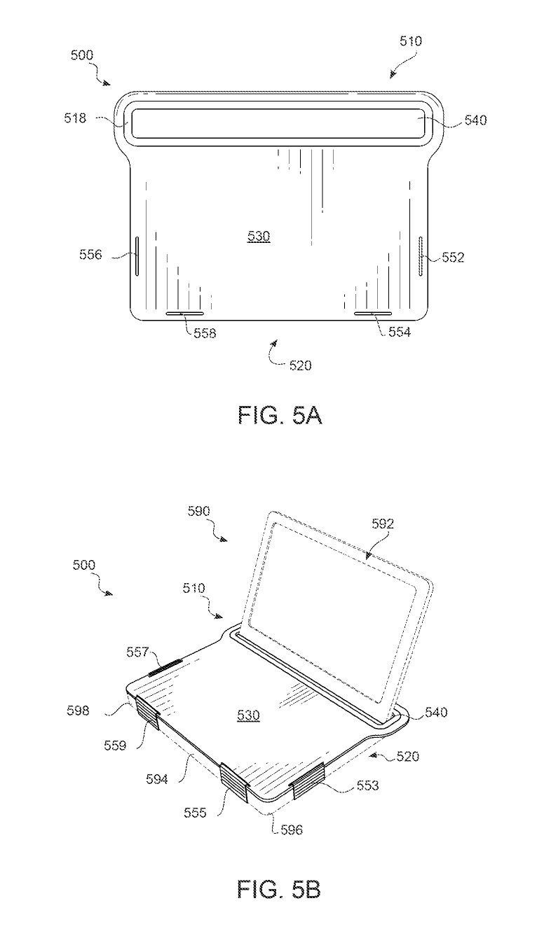

As shown in FIG. 3, the protective cover 300 may include an oval cutout 340 having curved ends 342, 344 along the ring 318 of the top section 310. The lower section slate portion 330 and strap slits 362, 364 of the lower portion 320 may be configured the same as shown in FIG. 1A, or as depicted in the alternative embodiments in FIGS. 5A, 6A and 7.

Turning now to FIGS. 4A and 4B, the top section 410 of the protective cover 400 is shown being placed over a laptop 490. The cutout 440 is placed over the laptop lid 492 and moved towards the laptop base 494. At rest (FIG. 4B), the bottom section 420 covers the laptop keyboard with the middle section 430 protecting unwanted activation of the keyboard buttons. The optional gripping surface 418 around the cutout is used to stabilize the protective cover about the laptop lid and the optional vertical slits 462, 464 may be used with a strap (FIG. 1A) to secure the protective cover to the laptop base.

As shown in FIGS. 5A and 5B, the middle portion 530 of the bottom section 520 of the protective cover 500 is configured to protect the keyboard of the laptop 590. The corners of the middle portion includes two vertical slits 552, 556 and two horizontal slits 554, 558 that may be joined with elastic straps positioned within the slits to engage and secure the protective cover to the corners 596, 598 of the laptop base 594. As heretofore described, the optional gripping surface 518 of the cutout 540 is used to stabilize the protective cover top section 510 around the laptop lid 592.

An alternative embodiment of a folding protective cover 600 is shown in FIGS. 6A and 6B. When the middle portions 632, 634 of the lower section 620 of the protective cover is adjacent the keyboard of the laptop 690, the lower section may be folded at seams 636 and 638 to expose a portion of the surface 696 of the keyboard base 694. The bottom edge 626 of the cover rests on the keyboard base surface when the protective cover is in the folded position. As heretofore described, the elongate cutout 640 is used to stabilize the protective cover top section 610 around the laptop lid 692.

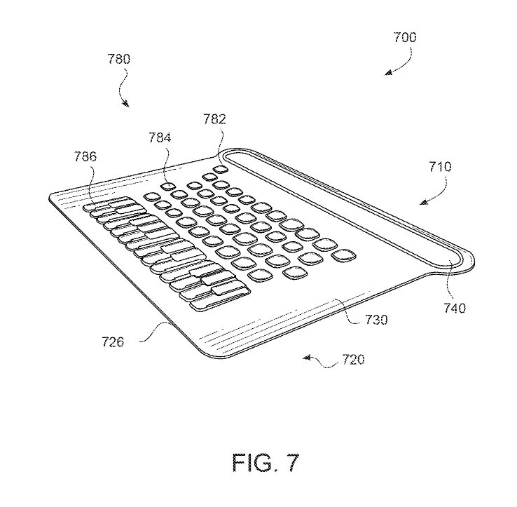

A further alternative embodiment of the protective cover 700 is shown in FIG. 7. In this ‘key top’ version of the lower section 720 of the present invention, the slate 730 may be configured with decorative and/or functional buttons 780 such as power 782 or play, pause and volume controls 784. For example, decorative or sound emitting ‘piano keys’ 786 may be configured near the bottom edge. As heretofore described, the cutout 740 is used to stabilize the protective cover top section 710 around a laptop lid.

In an embodiment of the present invention wherein the protective cover is configured with a keyboard in the lower section (the slate), the keyboard may contain different sized buttons with interactive capabilities. For example, larger buttons may be configured for ease of use by senior citizens and children. In addition, the keyboard may be operably connected to software (for example, piano-like functionality to generate sounds) resident in the laptop computer using a standard Universal Serial Bus (USB) type connector, Bluetooth wireless or other form of data transmitting and/or power interface. Further, the slate may be configured for use with a writing (drawing) stylus operably connected to software resident in the laptop computer.

The dimensions of the protective cover may be sized to accommodate different versions of laptop computers from the various manufactures. For example, the height of the combined upper and lower sections may range from twenty centimeters to forty centimeters, wherein thirty centimeters will be suitable for many laptop computers currently available. Similarly a suitable width of the upper section may range from thirty to fifty centimeters, wherein forty centimeters may be preferred. The thickness cross-section of the upper section may range from two millimeters to more than one centimeter, depending on the use of the protective cover surface, for example, an erasable marker board or a functional keyboard. The cutout in the upper section may be sized to provide adequate support around the laptop lid. A retaining strap, such as depicted in FIG. 1, may be sized according to the dimensions of a target laptop, wherein eighty-five centimeters is a useful length.

By way of example and not intended to be limiting, one embodiment (“thirteen inch”) of the protective cover shown in FIGS. 1A, 1B, 4A, and 4B has the following dimensions: (a) height of the combined upper and lower sections is 239.1 millimeters; (b) width of the upper section from a first (left) edge to a second (right) edge is 356.6 millimeters; (c) width of the lower section from a first (left) edge to a second (right) edge is 330.2 millimeters; (d) the length (width) of the cutout is 334.4 millimeters, having a height of 18.0 millimeters such that the thickness of the upper section surrounding the cutout is 11.1 millimeters; and (e) height of the slits in the lower section for retaining the strap that wraps around the laptop is 38.1 millimeters, having a width of 4.0 millimeters and being offset 17.4 millimeters from the side edge and 16.0 millimeters from the bottom edge.

A second embodiment (“fifteen inch”) of the protective cover shown in FIGS. 1A, 1B, 4A, and 4B (again, by way of example and not intended to be limiting) has the following dimensions: (a) height of the combined upper and lower sections is 279.5 millimeters; (b) width of the upper section from a first (left) edge to a second (right) edge is 417.0 millimeters; (c) width of the lower section from a first (left) edge to a second (right) edge is 386.1 millimeters; (d) the length (width) of the cutout is 391.0 millimeters, having a height of 21.0 millimeters such that the thickness of the upper section surrounding the cutout is 13.0 millimeters; and (e) height of the slits in the lower section for retaining the strap that wraps around the laptop is 38.1 millimeters, having a width of 4.0 millimeters and being offset 17.4 millimeters from the side edge and 16.0 millimeters from the bottom edge.

Although the embodiments of the present invention described herein are described with respect to laptop computers, the protective cover can be configured in various dimensions, measurements sizes and shapes that are suitable to other computing devices currently available or yet to be developed. The slate may be made from various materials, such as plastic, metal or cardboard with an upper finish suitable for use with an erasable marker or for imprinting with colored graphics. In addition, the entire protective cover may be made from various materials, for example, metals, plastics, shock resistant polymers such as polyurethane, composites or from any other materials that can provide the necessary shape, form and features that make them suitable for the purposes of this invention. A variety of further modifications and alternatives in and to the present invention will be apparent to persons skilled in the art without departing from the scope and spirit of the invention.

I claim:

1. A protective cover, comprising:
a first body section having a first end portion, a second end portion and a middle portion between the first end portion and the second end portion, wherein the middle portion forms an elongate cutout for receiving an object; and
a second body section having a first end portion, a bottom edge and a middle portion between the first end portion and the bottom edge, wherein the middle portion of the second body section is formed as a flat slate, wherein a width of the second body section is less than a width of the middle portion of the first body section, and wherein the first end portion of the second body section is connected to the second end portion of the first body section.

2. The protective cover of claim 1, wherein the elongate cutout is configured for receiving a lid of a laptop computer, the elongate cutout having a width less than the width of the second body section.

3. The protective cover of claim 2, wherein elongate cutout is rectangular in shape.

4. The protective cover of claim 2, wherein elongate cutout is oval in shape.

5. The protective cover of claim 2, wherein elongate cutout is configured to completely envelope the lid of a laptop computer.

6. The protective cover of claim 2, wherein elongate cutout is configured to partially envelope the lid of a laptop computer.

7. The protective cover of claim 1, wherein the middle portion of the second body section is formed with a first vertical cutout and a second vertical cutout.

8. The protective cover of claim 1, wherein the middle portion of the second body section is formed with a first vertical cutout, a second vertical cutout, first horizontal cutout, a second horizontal cutout, the first vertical cutout being adjacent to the first horizontal cutout and the second vertical cutout being adjacent to the second horizontal cutout.

9. The protective cover of claim 1, wherein the middle portion of the second body section is formed in at least two foldable sections.

10. The protective cover of claim 1, wherein the middle portion of the second body section is formed from a material for use with an erasable marker or for imprinting graphics.

11. The protective cover of claim 1, further including a plurality of raised buttons formed on the middle portion of the second body section.

12. The protective cover of claim 11, further including a connector from the protective cover to a laptop computer to provide an interface with the raised buttons and with software resident on the laptop computer.

13. The protective cover of claim 13, wherein the raised buttons form a keyboard for generating sounds from the laptop computer.

14. A method for using a protective cover on a laptop computer, comprising:
providing an upper body section having a top end portion, a bottom end portion and a middle portion between the top end portion and the bottom end portion, wherein the middle portion forms an elongate cutout for receiving a lid of a laptop computer;
providing a lower body section having a top end portion, a bottom edge and a middle portion between the top end portion and bottom edge, wherein the middle portion of the lower body section is formed as a flat slate, wherein a width of the lower body section is less than a width of the middle portion of the upper body section, and wherein the top end portion of the lower body section is connected to the bottom end portion of the upper body section;
placing the elongate cutout of the upper body section over a lid of a laptop computer; and
moving the middle portion of the lower body section into engagement with a base of the laptop to cover a keyboard in the laptop base.

15. The method of claim 14, wherein elongate cutout of the upper body section is configured to completely envelope the lid of a laptop computer, and placing the elongate cutout over a lid of a laptop computer causes the elongate cutout to completely surround the laptop lid.

16. The method of claim 14, wherein elongate cutout of the upper body section is configured to partially envelope the lid of a laptop computer, and placing the elongate cutout over a lid of a laptop computer causes the elongate cutout to partially surround the laptop lid.

17. The method of claim 14, wherein the middle portion of the lower body section is formed with a first vertical cutout and a second vertical cutout;
the method further comprising:
inserting a strap within the first vertical cutout and the second vertical cutout; and
engaging the strap with the base of the laptop so as to secure the protective cover to the laptop.

18. The method of claim 14, wherein the middle portion of the lower body section is formed with a first vertical cutout, a second vertical cutout, first horizontal cutout, a second horizontal cutout, the first vertical cutout being adjacent to the first horizontal cutout and the second vertical cutout being adjacent to the second horizontal cutout;
the method further comprising:
inserting a first strap within the first vertical cutout and the first horizontal cutout;
inserting a second strap within the second vertical cutout and the second horizontal cutout;
engaging the first strap onto a first corner of the base of the laptop; and
engaging the second strap onto a second corner of the base of the laptop so as to secure the protective cover to the laptop.

19. The method of claim 14, wherein the middle portion of the lower body section is formed with a first foldable section and a second foldable section;
the method further comprising:
bending the middle portion of the lower body section to move the first foldable section and the second foldable section above the base of the laptop; and
resting the bottom edge of the lower body section on the base of the laptop so as to expose a portion of the laptop keyboard.
